(19) United States
(12) Patent Application Publication
(10) Pub. No.: US 2004/0030764 A1
(43) Pub. Date: Feb. 12, 2004

(54) Identity assertion token principal mapping for common secure interoperability

(75) Inventors: Peter Daniel Birk, Austin, TX (US); David Yu Chang, Austin, TX (US); Derek Wan Hok Ho, Austin, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY

(21) Appl. No.: 10/216,636

(22) Filed: Aug. 8, 2002

(51) Int. Cl. G06F 15/173

(52) U.S. Cl. 709/223

(57) ABSTRACT

Identity token principal mapping, including receiving in a target system a CORBA message invoking a member method on the target system, the message including a security context including an identity token including an asserted identity, the identity token having an identity token type, the target system having an authentication type, and granting to the asserted identity, in dependence upon the authentication type and in dependence upon the identity token type, authorization privileges of a corresponding user account in the target system.

### BACKGROUND OF THE INVENTION

1. Field of the Invention

The field of the invention is data processing, or, more specifically, methods, systems, and products for identity assertion token principal mapping for common secure interoperability.

2. Description Of Related Art

The Object Management Group (“OMG”) is an open membership, not-for-profit consortium that produces and maintains computer industry specifications for interoperable enterprise applications. The Common Secure Interoperability Specification, version 2 (“CSIv2”), is one of the computer industry specifications for interoperable enterprise applications produced by the OMG. CSIv2 defines the Security Attribute Service (“SAS”), a CORBA security protocol supporting interoperable authentication and authorization. The CSIv2 specification, as well as the CORBA specification and all other OMG specifications referred to in this disclosure, is available for free inspection and download from the OMG website at www.omg.org. “CORBA” refers to the Common Object Request Broker Architecture, another of the computer industry specifications for interoperable enterprise applications produced by the OMG. CORBA is a standard for remote procedure invocation first published by the OMG in 1991. CORBA can be considered a kind of object-oriented way of making “RPCs” or remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

Whenever a client program acquires an object reference, decoded from a stringified object reference, from a Naming Service, or as result from another method invocation, an ORB creates a stub object. Since a stub object cannot exist without an object reference, and an object reference rarely exists outside a stub object, these two terms are often used synonymously. For the server side, a skeleton is generated by the IDL compiler. A developer derives from that skeleton and adds the methods' implementation; an object instance of such an implementation class is called a ‘servant.’ The generated skeleton receives requests from the ORB, unmarshalls communicated parameters and other data, and performs upcalls into the developer-provided code. This way, the object implementation also looks like a ‘normal’ class. “GIOP” refers to the General Inter-ORB Protocol, the CORBA protocol that defines structures and formats for passing messages among heterogeneous computers and their various architectures. GIOP is not based on any particular network protocol, like IPX or TCP/IP. In order to support interoperability, the OMG defines GIOP on top of a specified transport that will be supported by all vendors. Genuine interoperability is not provided, however, when there is a detailed and compact message specification that is nevertheless implemented by vendors over different underlying transport mechanisms. The OMG therefore took the additional step of standardizing GIOP over the most widely used communication transport platform: tcp/ip. GIOP defined to function over tcp/ip is called “IIOP,” the Internet Inter-ORB Protocol. Because of the general usefulness of tcp/ip, this disclosure, in describing example embodiments, tends to use the terms GIOP and IIOP more or less interchangeably, depending on context, although the use of the term IIOP is not intended to limit application of embodiments of the present invention to the single transport protocol suite tcp/ip.

“SSL” refers to the Secure Sockets Layer, a protocol developed by Netscape for transmitting private documents via the Internet. SSL works by using a public key to encrypt data that's transferred over an SSL connection. Modern browsers support SSL, and many Web sites use SSL to obtain confidential user information, such as credit card numbers. By convention, Uniform Resource Identifiers (“URIs”) or Uniform Resource Locators (“URLs”) that require an SSL connection start with ‘HTTPS’ instead of ‘HTTP.’

“Authentication” means verification of a principal's network identity. A “principal” is an entity that is capable of believing that it can communicate securely with another entity. “Authorization” refers to the scope of access privilege to be granted to a principal, whether a particular principal is authorized, for example, to read, write, or execute particular programs or resources on a target system.

FIG. 1 sets forth a block diagram illustrating prior art relations among the principal protocols and entities of the Common Object Request Broker Architecture. FIG. 1 shows a client (202) coupled for application purposes through an IDL stub (210) to an Object Request Broker (“ORB”) (214). The ORB is shown as a conceptual ORB backbone, because clients view CORBA calls from clients as being calls to an ORB even though the ORB software as such resides to a large extent on servers. Each client knows how to contact at least one local ORB, and ORBs generally can be viewed as comprising a backbone coupled through, for example, IIOP or the Internet Inter-ORB Protocol. FIG. 1 also shows a server (206) coupled to the ORB (214) through an IDL skeleton (212). “IDL” refers to CORBA's Interface Definition Language. IDL stubs and skeletons map client requests, or invocations of member methods, to the IDL understood by the ORB.

The client (202) is shown as comprising a client application called a browser (204). Although many client applications in fact comprise browsers, many different kinds of client applications invoke CORBA objects. In the terminology of CSIv2, client-side functionality and structure is generally referred to as ‘CSS,’ meaning Client Security System. In this disclosure, for generality and clarity, and with dependence upon context, we speak generally of “clients” or “a client” as including all client-side application software and structure, apparatus, processors, memory, and so on.

Server-side applications are known in the art as “servants” (208, 226). In the context of identity assertion, however, as can be seen from reference to CSIv2, the functionality and structure ordinarily thought of as ‘server-side,’ is spoken of in terms of ‘Target Security Systems’ or ‘TSSs.’ For generality and clarity, however, in this disclosure, unless a particular context requires otherwise, we usually refer to all server-side functionality and structure as a “target” or as a “target system.”

FIG. 1 depicts two targets (206, 224). The first target (206) of FIG. 1 illustrates receiving a CORBA call (232) bearing no asserted identity; that is, the authenticated identity for the principal of the call (client—202) is the principal for whom the call is made. The second target (224) of FIG. 1 illustrates a target's receiving a CORBA call (234) bearing an asserted identity; that is, the authenticated identity for the caller (server—206) is not the same as the principal (client—202) for whom the call is made. In this architecture, the first target (206) functions as an intermediary—and is sometimes referred to as such. This fact pattern is the one with which we are primarily concerned in this disclosure. It arises when a client (232) issues a CORBA call invoking a member method remotely on a target (206) when the target, in order to carry out the call, must in turn call a member method remotely on a second target (224). The first target (206) optionally authenticates in the conventional fashion of client authentication in its own right. In accessing resources on the second target, however, because it is calling on behalf of another principal rather than itself, the intermediary wishes to assert only the privileges of its calling client, which may or may not be the same as the privileges of the intermediary on the second target system. The intermediary signifies its intention to assert only the privileges of its calling client by including in a security context an identity token, described in more detail below.

FIG. 1 also depicts a standard protocol stack for secure networked data communications in the CORBA architecture. The stack includes a transport and network layer, tcp/ip (220); a security transport layer, the Secure Sockets Layer or “SSL” (218); an inter-ORB protocol communications layer labeled “GIOP/IIOP” (216); and the SAS itself (222). Strictly speaking, “tcp,” the “Transmission Control Protocol,” is a separate layer residing above “ip,” the “Internet Protocol.” The two are so often spoken of together, however, that we label them together in FIG. 1. As discussed in more detail below, “GIOP” is the General Inter-ORB Protocol, and “IIOP” is the Internet Inter-ORB Protocol. That is, IIOP is an internet-oriented implementation of GIOP, which is why we label these two together in FIG. 1. Again strictly speaking, CSIv2 describes SAS as comprising two protocol sublayers, one for client authentication and one for identity assertion. In this disclosure, however, we are so directly concerned with identity assertion that we think it more useful for clarity of explanation to depict and discuss SAS as a single protocol layer (222).

The SAS protocol is designed to exchange its protocol elements in the service context of GIOP request and reply messages that are communicated over a connection-based transport. The SAS protocol is intended to be used in environments where transport layer security, such as that available via SSL/TLS or SECIOP, is used to provide message protection (that is, integrity and or confidentiality) and server-to-client authentication. The SAS protocol provides client authentication, delegation, and privilege functionality (authorization) that may be applied to overcome corresponding deficiencies in an underlying transport. The SAS protocol facilitates interoperability by serving as the higher-level protocol under which secure transports may be unified.

The SAS protocol is modeled after the Generic Security Service API (GSSAPI) token exchange paradigm. The GSSAPI is a specification of the Internet Engineering Task Force (“IETF”) published in RFC 1508 and several related RFCs. An “RFC” is a Request For Comment, the standard specification publication method of the IETF. IETF Working Groups are important standards bodies for the Internet. RFC1508 and many other RFCs are available for review and downloading from the Internet RFC Archive website at www.faqs.org/rfcs/index.html.

The SAS is based upon the use of a common transport-layer security mechanism, such as that provided by SSL. SAS assumes that the transport layer provides message protection as needed to protect GIOP input and output request arguments. SAS assumes that the transport layer provides target-to-client authentication as necessary to identify the target for the purpose of ensuring that the target is the intended target of a particular CORBA call.

The SAS protocol provides both a client authentication service as well as an identity assertion service. SAS client authentication is used to perform client authentication in cases where client authentication is not provided through the transport layer. It is possible for several reasons that client authentication is not performed in the transport layer. The SSL protocol when used as the transport layer, for example, does not enforce client authentication. Moreover, in any given environment, certificate-based client authentication may not be feasible because clients often do not have certificates.

In addition to client authentication, SAS also provides for identity assertion. That is, SAS may be used by a client to assert identity attributes that differ from the client's authentication identity (as established in the transport and/or SAS authentication layers). This identity assertion capability is the foundation of a general-purpose impersonation mechanism that makes it possible for an intermediate to act on behalf of some identity other than itself. An intermediate's authority to act on behalf of another identity may be based on trust by the target in the intermediate, or on trust by the target in a privilege authority that endorses the intermediate to act as proxy for the asserted identity. Identity assertion may be used by an intermediate to assume the identity of its callers in its calls to additional targets.

The SAS protocol element sent to initiate a security context carries specific security tokens as necessary to establish the SAS functionality corresponding to the context. Standard formats are employed in specific authentication and attribute tokens. If, for example, the context includes an attribute-layer identity assertion, the asserted identity will be represented in a standard name form corresponding to the technology domain of the asserted identity.

SAS identity tokens are the data structures used to communicate, through a particular context, both an asserted identity and the technology domain of the asserted identity. An identity token carries a representation of an invocation identity for a call (that is, the identity under which the call is to be authorized). An identity_token is used to assert a caller identity when that identity differs from the identity proven by authentication in the authentication layer(s). If the caller identity is intended to be the same as that established in the authentication layer(s), then it does not need to be asserted in an identity_token. The following code is an excerpt, from pages 61-62 of CSIv2, defining identity tokens in Common Data Representation (“CDR”) transfer syntax:

typedef unsigned long IdentityTokenType;

//Additional standard identity token types shall only be defined by the //OMG. All IdentityTokenType constants shall be a power of 2.

const IdentityTokenType ITTAbsent=0;

const IdentityTokenType ITTAnonymous=1;

const IdentityTokenType ITTPrincipalName=2;

const IdentityTokenType ITTX509CertChain=4;

const IdentityTokenType ITTDistinguishedName=8;

typedef sequence <octet>IdentityExtension;

union IdentityToken switch (IdentityTokenType){

case ITTAbsent: boolean absent;

case ITTAnonymous: boolean anonymous;

case ITTPrincipalName: GSS_NT_ExportedName principal_name;

case ITTX509CertChain: X509CertificateChain certificate_chain;

case ITTDistinguishedName: X501DistinguishedName dn;

default: IdentityExtension id;

};

The typedef IdentitytokenType is used to enumerate values for ITAbsent, ITTAnonymous, ITTPrincipalName, ITTX509CertChain, and ITTDistinguishedName. The enumerated values identify supported authentication technology domains and have the meanings set forth in the following table from page 14 of CSIv2:

| Value of | |
|---|---|
| ItentityTokenType | Meaning |
| ITTAbsent | Identity token is absent; the message conveys |
| | no representation of identity assertion |
| ITTAnonymous | Identity token is being used to assert a value- |
| | less representation of an unauthenticated caller |
| ITTPrincipalName | Identity token contains an encapsulation octet |
| | stream containing a GSS mechanism-inde- |
| | pendent exported name object as defined in |
| | [IETF RFC 2743] |
| ITTDistinguishedName | Identity token contains an encapsulation |
| | octet stream containing an ASN.1 encoding of |
| | an X.501 distinguished name |
| ITTX509CertChain | Identity token contains an encapsulation |
| | octet stream containing an ASN.1 encoding of |
| | a chain of X.509 identity certificates |

An SAS security context used to establish security for a call according to CSIv2 has the following data structure:

struct EstablishContext {

ContextId client_context_id;

AuthorizationToken authorization_token;

IdentityToken identity_token;

GSSToken client_authentication_token;

};

If an SAS message carrying an EstablishContext structure contains an identity token, then it is the responsibility of the target of the message to extract a principal identity from the identity token in the context and determine whether the client identity established in an authenticating layer (SSL or SAS) is trusted to assert the extracted identity. If the authenticated identity is so trusted, the asserted identity is used as the caller identity in the target's authorization determination. According to SAS, in such cases, a target evaluates trust by applying the target's own trust rules to the client authentication identity and the asserted identity. The specification is silent, however, regarding exactly how a target system receiving CORBA calls bearing asserted identities is to go about developing and applying trust rules.

### SUMMARY OF THE INVENTION

Exemplary embodiments of the invention typically include methods for identity token principal mapping. Exemplary embodiments include receiving in a target system a CORBA message invoking a member method on the target system, the message including a security context including an identity token. In such embodiments, an identity token comprises an asserted identity. The identity token has an identity token type, and the target system has an authentication type. Exemplary embodiments typically include granting to the asserted identity, in dependence upon the authentication type and in dependence upon the identity token type, authorization privileges of a corresponding user account in the target system.

In some embodiments, the identity token type is ITTPrincipalName and the asserted identity includes a GSS Export Name including an asserted realm name and an asserted principal name. In such embodiments, the authentication type can comprise LTPA authentication, and granting authorization privileges can include granting, to the asserted identity, authorization privileges of an LTPA principal whose LDAP entry comprises the asserted realm name and, as its common name, the asserted principal name. In some embodiments, the authentication type comprises authentication in the local operating system of the target system, and granting authorization privileges includes granting authorization privileges of a corresponding user account in the local operating system having as its user name the asserted principal name. In some embodiments, the authentication type comprises Kerberos authentication, and granting authorization privileges includes granting authorization privileges of a corresponding Kerberos principal in the local realm having as its principal name the asserted principal name.

In other embodiments, the identity token type is ITTDistinguishedName, and the asserted identity includes an X.501 distinguished name. In such embodiments, the authentication type can comprise LTPA authentication, and granting authorization privileges can include granting, to the asserted identity, authorization privileges of an LTPA principal having an LDAP distinguished name identical to the X.501 distinguished name. In some embodiments, the authentication type includes authentication in the local operating system of the target system, the X.509 distinguished name includes a common name, and granting authorization privileges includes granting authorization privileges of a corresponding user account in the local operating system having as its user name the common name of the X.501 distinguished name. In other embodiments, the authentication type includes Kerberos authentication, the X.509 distinguished name includes a common name, and granting authorization privileges includes granting authorization privileges of a corresponding Kerberos principal in the local realm having as its Kerberos principal name the common name of the X.501 distinguished name.

In still further embodiments of the invention, the identity token type is ITTX509CertChain, the identity token includes a sequence of at least one X.509 certificates, the sequence includes a first X.509 certificate, and the asserted identity includes a distinguished name of the first X.509 certificate. In such embodiments, the authentication type can comprise LTPA authentication, and granting authorization privileges can include granting, to the asserted identity, authorization privileges of an LTPA principal having an LDAP distinguished name identical to the distinguished name of the first X.509 certificate. In some embodiments, the distinguished name of the first X.509 certificate includes a common name, the authentication type includes authentication in the local operating system of the target system, and granting authorization privileges includes granting authorization privileges of a corresponding user account in the local operating system having as its user name the common name of the first X.509 certificate. In other embodiments, the distinguished name of the first X.509 certificate includes a common name, the authentication type includes Kerberos authentication, and granting authorization privileges includes granting authorization privileges of a corresponding Kerberos principal in the local realm having as its Kerberos principal name the common name of the first X.509 certificate.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a prior art block diagram of a Common Object Request Broker Architecture.

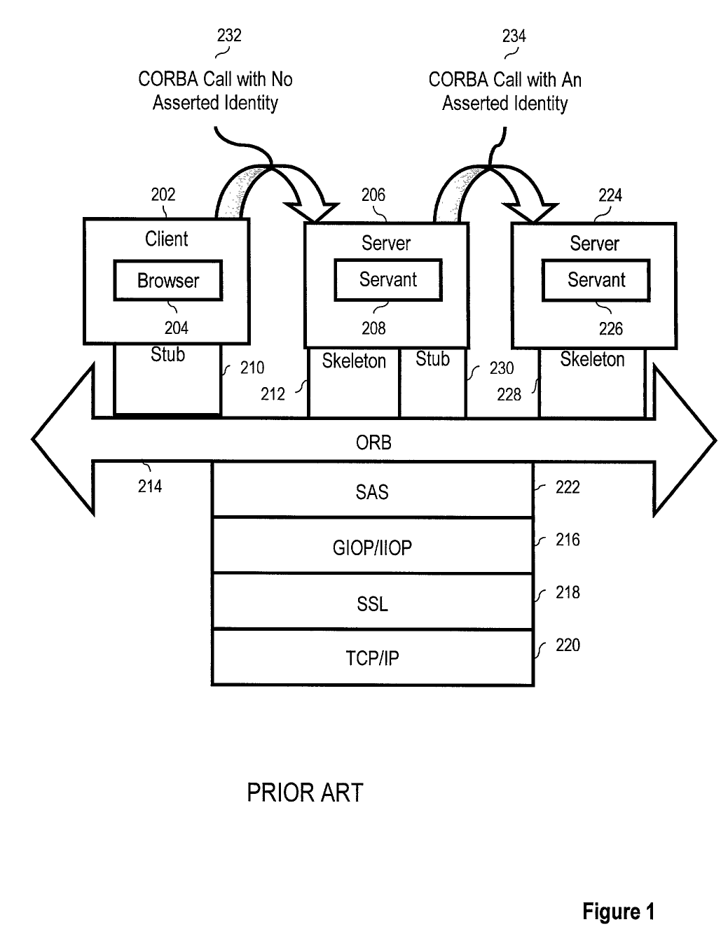

FIG. 2 sets forth a data flow diagram illustrating a CORBA call bearing an asserted identity, a CORBA message comprising an identity token.

FIG. 3 sets forth a data flow diagram illustrating a CORBA call bearing an asserted identity with an identity token type of ITTPrincipalName for an LTPA authentication type in the target system.

FIG. 4 sets forth a data flow diagram illustrating a CORBA call bearing an asserted identity with an identity token type of ITTPrincipalName for an authentication in the local operating system in the target system.

FIG. 5 sets forth a data flow diagram illustrating a CORBA call bearing an asserted identity with an identity token type of ITTPrincipalName for Kerberos authentication type in the target system.

FIG. 6 sets forth a data flow diagram illustrating a CORBA call bearing an asserted identity with an identity token type of ITTDistinguishedName for an LTPA authentication type in the target system.

FIG. 7 sets forth a data flow diagram illustrating a CORBA call bearing an asserted identity with an identity token type of ITTDistinguishedName for an authentication in the local operating system in the target system.

FIG. 8 sets forth a data flow diagram illustrating a CORBA call bearing an asserted identity with an identity token type of ITTDistinguishedName for Kerberos authentication type in the target system.

FIG. 9 sets forth a data flow diagram illustrating a CORBA call bearing an asserted identity with an identity token type of ITTX509CertChain for an LTPA authentication type in the target system.

FIG. 10 sets forth a data flow diagram illustrating a CORBA call bearing an asserted identity with an identity token type of ITTX509CertChain for an authentication in the local operating system in the target system.

FIG. 11 sets forth a data flow diagram illustrating a CORBA call bearing an asserted identity with an identity token type of ITTX509CertChain for Kerberos authentication type in the target system.

### DETAILED DESCRIPTION OF EXEMPLARY EMBODIMENTS

Introduction

The present invention is described to a large extent in this specification in terms of methods for identity assertion token principal mapping for common secure interoperability. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

Definitions

In this specification, the terms “field,” “data element,” and “attribute,” unless the context indicates otherwise, generally are used as synonyms, referring to individual elements of digital data. Aggregates of data elements are referred to as “records” or “data structures.” Definitions of complex data structures that include member methods, functions, or software routines in addition to data elements are referred to as “classes.” Instances of complex data structures are referred to as “objects” or “class objects.” Aggregates of records are referred to as “tables” or “files.” Aggregates of files are referred to as “databases.”

“LDAP” refers to the Lightweight Directory Access Protocol, a set of protocols for accessing information directories. LDAP is based on the standards contained within the X.500 standard, but is significantly simpler. And unlike X.500, LDAP supports tcp/ip, an important feature for Internet-oriented directory access. Both LDAP and X.500 implement hierarchical directories in which particular sets of attributes of directory entries comprise distinguished names.

“X.500” is a joint standard of both the International Standards Organization (“ISO”) and the International Telecommunication Union (“ITU”) defining structure for global directories. X.500 directories are hierarchical with different levels for each category of information, such as country, state, and city. Both LDAP and X.500 implement hierarchical directories in which particular sets of attributes of directory entries comprise distinguished names. X.501 is the X.500 specification for directory models as such.

“X.509” is part of the X.500 family of standards from the ISO and the ITU. X.509 is most widely used standard for defining digital certificates. A digital certificate is a conventional data structure for communicating public keys and digital signatures. Digital certificates are used in client authentication, server authentication, and message protection. A certificate is issued by a Certificate Authority. Certificates generally contain data elements for the certificate holder's name, an identification number, expiration dates, a copy of the certificate holder's public key (for encrypting and decrypting messages and digital signatures), and the digital signature of a Certificate Authority so that a recipient can verify that the certificate is genuine. In operation, the recipient of an encrypted message uses a Certificate Authority's public key to decode a digital certificate attached to a message, verifies the certificate as issued by the Certificate Authority, and then obtains the sender's public key and identification information held within the certificate. With this information, the recipient can send an encrypted reply.

A distinguished name (“DN”) is composed of a sequence of directory entry attributes separated by commas, for example, in an LDAP directory or an X.500 directory. A distinguished name is a path through a hierarchical LDAP or X.500 directory that uniquely identifies a particular directory entry. In an LDAP directory of users, for example, a distinguished name can comprise the attributes: cn=Mike Smith, ou=Austin, c=US, kr=Local01, representing a directory entry for a user with the common name (cn) Mike Smith under the organizational unit (ou) Austin in the organization (o) IBM in the country (c) US in Kerberos realm (kr) Local01.

Detailed Description

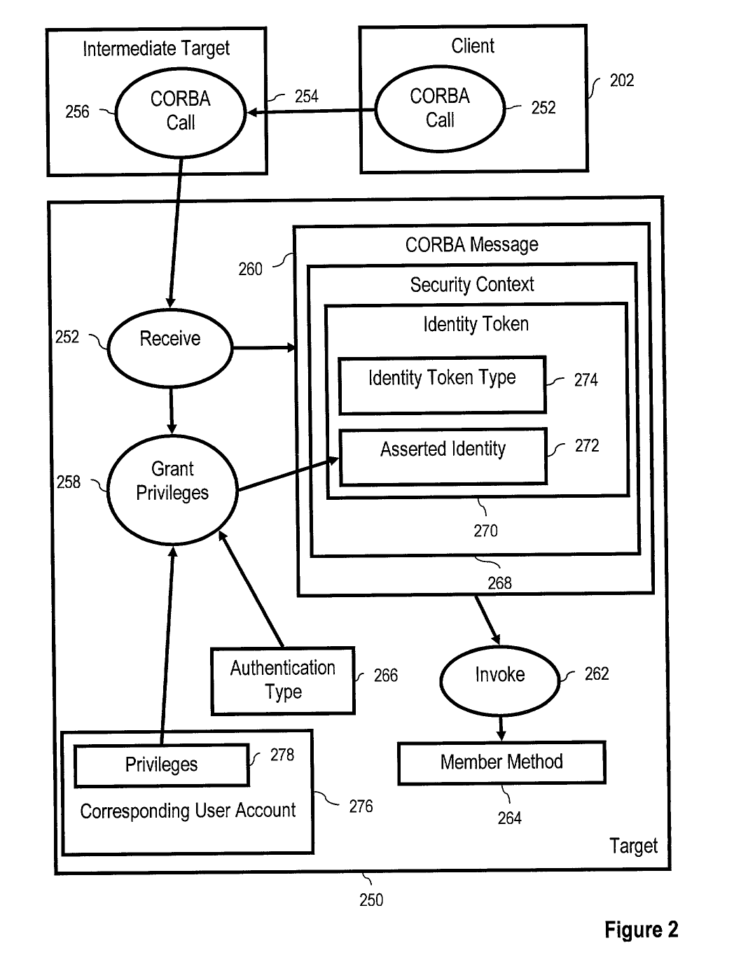

FIG. 2 sets forth a data flow diagram depicting a method for identity token principal mapping. In the method of FIG. 2, a target system (250) receives (252) a CORBA call bearing an asserted identity denote by the presence of an identity token (270). The CORBA call of FIG. 2 originates in a call from a client (202) to an intermediary (254) that results in a further call to the target system (250). In the method of FIG. 2, it is the intermediate target's identity that is authenticated through a transport layer such as SSL or through the client authentication functions of SAS. In the further call to the target system (250), however, the intermediary (254) asserts the identity of the client (202).

The method of FIG. 2 includes receiving (252) in a target system (250) a CORBA message (260) invoking (262) a member method (264) on the target system (250). The CORBA message (260) includes a security context (268) comprising an identity token (270). The identity token (270) comprises an asserted identity (272). The identity token (270) has an identity token type (274), and the target system (250) has an authentication type (266).

The method of FIG. 2 also includes granting (258), to the asserted identity (272), authorization privileges (278) of a corresponding user account (276) in the target system (250). Granting (258) authorization privileges (278) in the illustrated method, as described in more detail below, is carried out in dependence upon the authentication type (266) and in dependence upon the identity token type (274).

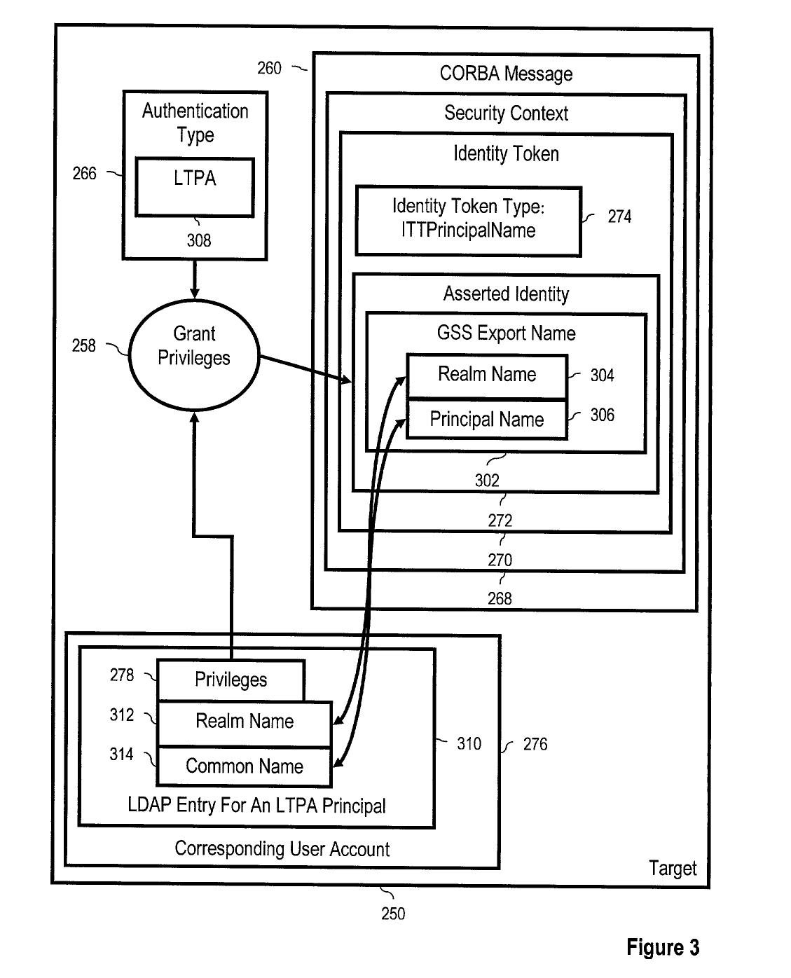

FIG. 3 sets forth a data flow diagram depicting a further exemplary method for identity token principal mapping. In the method of FIG. 3, the identity token type (274) is set to “ITTPrincipalName,” and the asserted identity (272) comprises a GSS Export Name (302) comprising an asserted realm name (304) and an asserted principal name (306).

This section specifies a mechanism-independent level of encapsulating representation for names exported via the GSS_Export_name( ) call, including an object identifier representing the exporting mechanism.

“GSS Export Name” refers to an encoding of a GSS Mechanism-Independent Exported Name Object as defined in IETF RFC 2743, Section 3.2, “GSS Mechanism-Independent Exported Name Object Format,” p. 84. More particularly, GSS Export Names are a mechanism-independent level of encapsulating representation for names exported via the GSS_Export_name( ) call of the GSSAPI, including an object identifier representing an exporting mechanism. The data structure for GSS Export Names, described in more detail in RFC 2743, is as follows:

| Field Name | Description |
|---|---|
| TOK_ID | Token Identifier—For exported |
| | name objects, this is hex 04 01. |
| MECH_OID_LEN | Length of the mechanism object |
| | identifier (“OID”) |
| MECH_OID | The mechanism OID |
| NAME_LEN | Length of name |
| NAME | The exported name itself |

In the further exemplary method of FIG. 3, the authentication type (266) comprises LTPA authentication (308), and granting (258) authorization privileges further comprises granting, to the asserted identity, authorization privileges (278) of an LTPA principal whose LDAP entry (310) comprises the asserted realm name (304, 312) and, as its common name (314), the asserted principal name (306).

“LTPA” is IBM's cookie-based Lightweight Third Party Authentication protocol. LTPA is implemented with an IBM plug-in for web security servers called the Access Manager Plug-in for Web Servers. When a principal makes an identity-asserting CORBA call to a target using LTPA authentication, the principal first authenticates to the plug-in. Upon successful authentication, the plug-in generates an LTPA cookie on behalf of the principal. The LTPA cookie, which serves as an authentication token for the target (which is typically a web application server), contains principal identity and password information. This information is encrypted using a password-protected secret key shared between the plug-in and the target. The plug-in inserts the cookie in the HTTP header of a request that is sent to the target. The target receives the request, decrypts the cookie, and authenticates the principal based on the identity information supplied in the cookie. Principals (“PTPA principals”) known to an LTPA plug-in, and therefore amenable to LTPA authentication, typically are registered through LTPA in an LDAP directory.

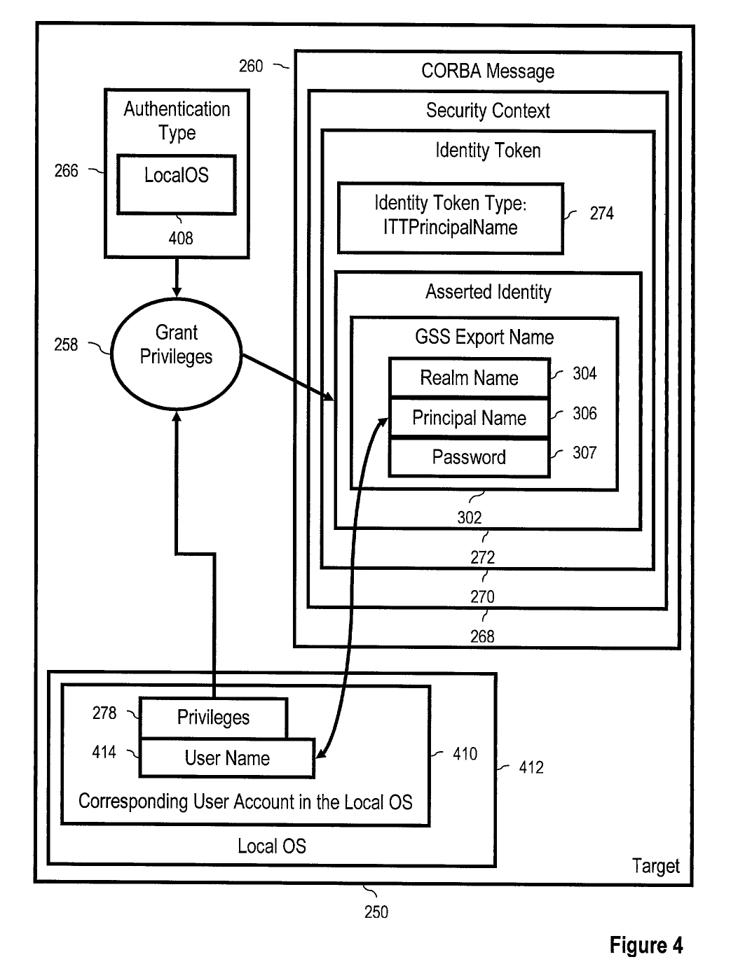

FIG. 4 sets forth a data flow diagram depicting a further exemplary method for identity token principal mapping. In the method of FIG. 4, the identity token type (274) is set to “ITTPrincipalName,” and the asserted identity (272) comprises a GSS Export Name (302) comprising an asserted realm name (304) and an asserted principal name (306). In the method of FIG. 4, the authentication type (266) comprises authentication in the local operating system (408) of the target system (250), and granting authorization privileges (258) further comprises granting authorization privileges (278) of a corresponding user account (410) in the local operating system (412). The corresponding user account in the local operating system has as its user name (414) the asserted principal name (306).

Authentication through the local operating system typically means that SAS calls through the local operating system's standard API (Application Programming Interface) with a user name and a password. As described just above, the asserted principal name (306) is tested to match the user name (714). The local operating system typically requires also a password for authentication. The GSS Export Name (302) for embodiments according to FIG. 4, therefore, typically are encoded also to include a password (307) for use in calls to the local operating system.

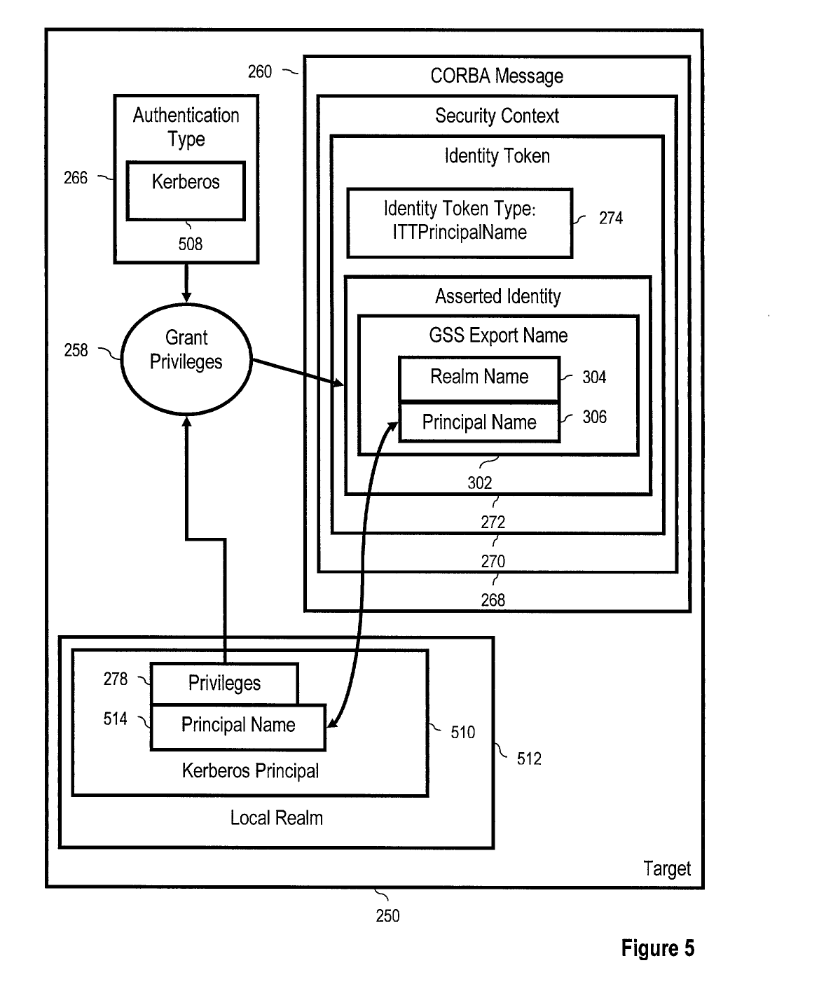

FIG. 5 sets forth a data flow diagram depicting a further exemplary method for identity token principal mapping. In the method of FIG. 5, the identity token type (274) is set to “ITTPrincipalName,” and the asserted identity (272) comprises a GSS Export Name (302) comprising an asserted realm name (304) and an asserted principal name (306). In the method of FIG. 5, the authentication type (266) comprises Kerberos authentication (508), and granting (258) authorization privileges further comprises granting authorization privileges (278) of a corresponding Kerberos principal (510) in the local realm (512) having as its principal name (514) the asserted principal name (306).

Kerberos is a network authentication protocol developed by and freely available from Massachusetts Institute of Technology. The Kerberos protocol uses strong, secret-key cryptography so that a client can prove its identity to a target server (and vice versa) across an insecure network connection. More particularly, a client or ‘Kerberos principal’ proves its identity to a Kerberos Key Distribution Center (“KDC”) by use of a client password and then receives in return from the KDC a Kerberos ‘ticket’ containing the client's identification encrypted with the target server's secret key. The Kerberos principal then uses the ticket to authenticate the principal to the target.

To scale large networks like the Internet, more than one KDC is needed. Large networks using Kerberos authentication therefore are divided into ‘realms.’ Each Kerberos realm has its own KDC. As a practical matter, the divisions among realms are often made on organizational boundaries, although that is not a requirement of the Kerberos specification itself.

Persons of skill in the art will realize that this description of Kerberos is summary in nature. The complete Kerberos specification is available for review or download from http://web.mit.edu/kerberos. A free implementation of Kerberos is available from MIT, and Kerberos is available in many commercial products as well.

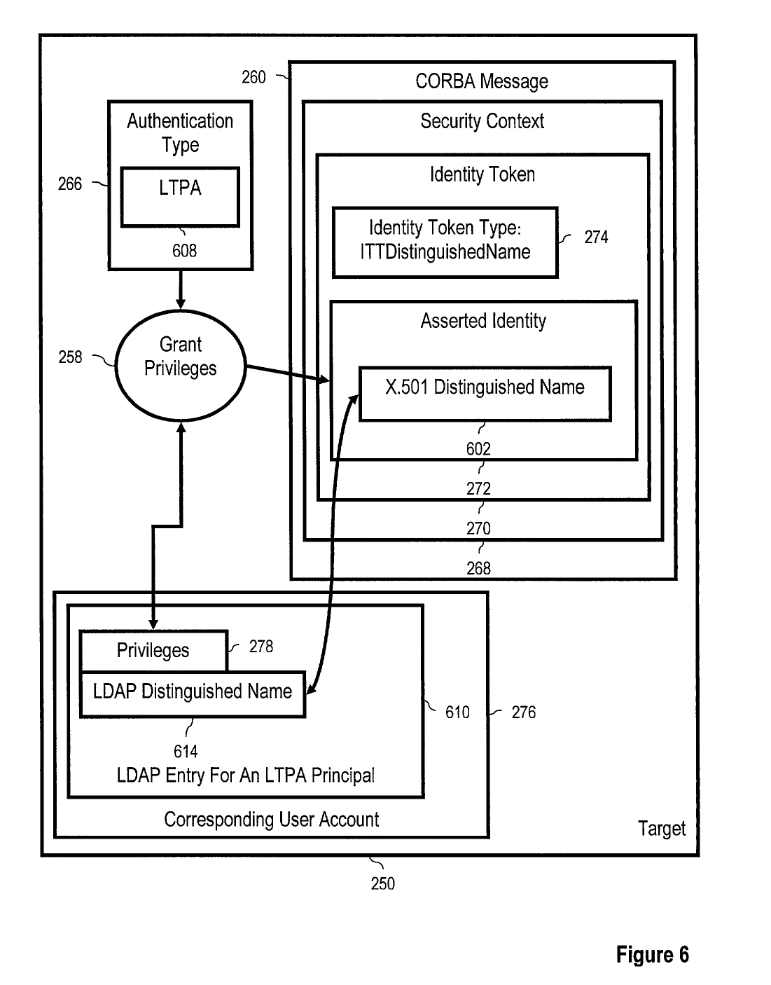

FIG. 6 sets forth a data flow diagram depicting a still further exemplary method for identity token principal mapping. In the method of FIG. 6, the identity token type (274) is ITTDistinguishedName, and the asserted identity (272) comprises an X.501 distinguished name (602). In the method of FIG. 6, the authentication type (266) comprises LTPA authentication (608). According to the method of FIG. 6, granting (258) authorization privileges further comprises granting, to the asserted identity (272), authorization privileges (278) of an LTPA principal (610) having an LDAP distinguished name (614) identical to the X.501 distinguished name (602).

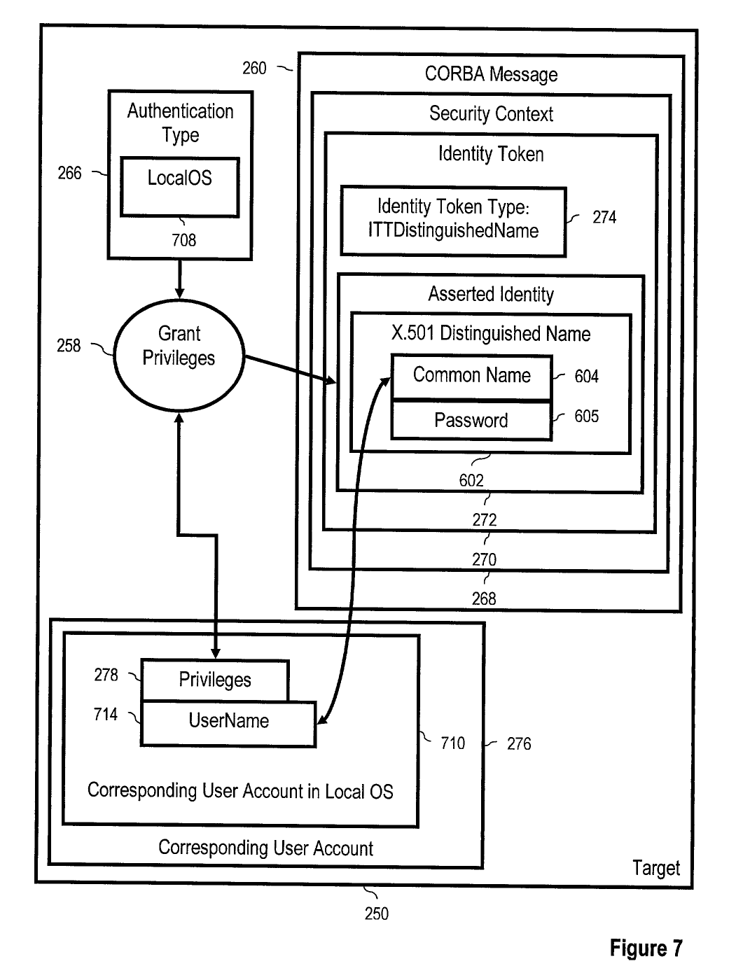

FIG. 7 sets forth a data flow diagram depicting a still further exemplary method for identity token principal mapping. In the method of FIG. 7, the identity token type (274) is ITTDistinguishedName, and the asserted identity (272) comprises an X.501 distinguished name (602). In the method of FIG. 7, the authentication type (266) comprises authentication in the local operating system (708) of the target system, and the X.509 distinguished name includes a common name. According to the method of FIG. 7, granting (258) authorization privileges further comprises granting authorization privileges (278) of a corresponding user account (710) in the local operating system having as its user name (714) the common name of the X.501 distinguished name.

As mentioned earlier, authentication through the local operating system typically means that SAS calls through the local operating system's standard API with a user name (714) and a password. In the case where the identity token type (274) is ITTDistinghishedName, the common name (604) is tested to match the user name (714) at the level of the local operating system. The local operating system typically requires also a password for authentication. The X.501 distinguished name (602) for embodiments according to FIG. 7, therefore, typically is encoded also to include a password (605) for use in the local operating system.

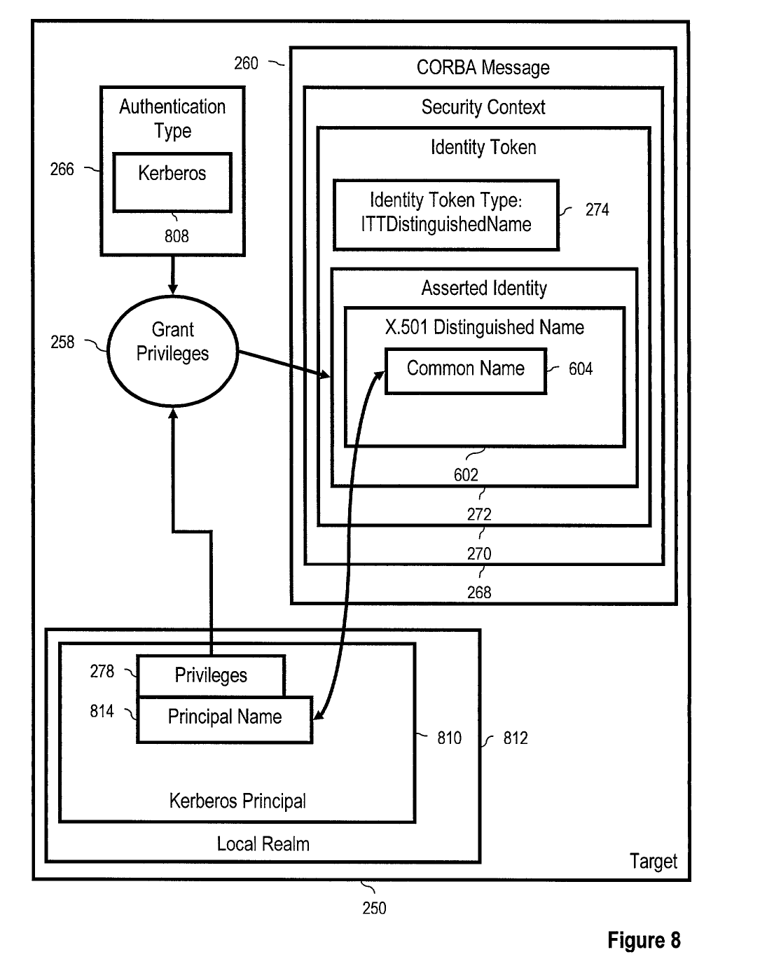

FIG. 8 sets forth a data flow diagram depicting a still further exemplary method for identity token principal mapping. In the method of FIG. 8, the identity token type (274) is ITTDistinguishedName, and the asserted identity (272) comprises an X.501 distinguished name (602). In the method of FIG. 8, the authentication type (266) comprises Kerberos authentication (808), and the X.509 distinguished name (602) includes a common name (604). According to the method of FIG. 8, granting (258) authorization privileges further comprises granting authorization privileges (278) of a corresponding Kerberos principal (810) in the local realm (812) having as its Kerberos principal name (814) the common name (604) of the X.501 distinguished name (602).

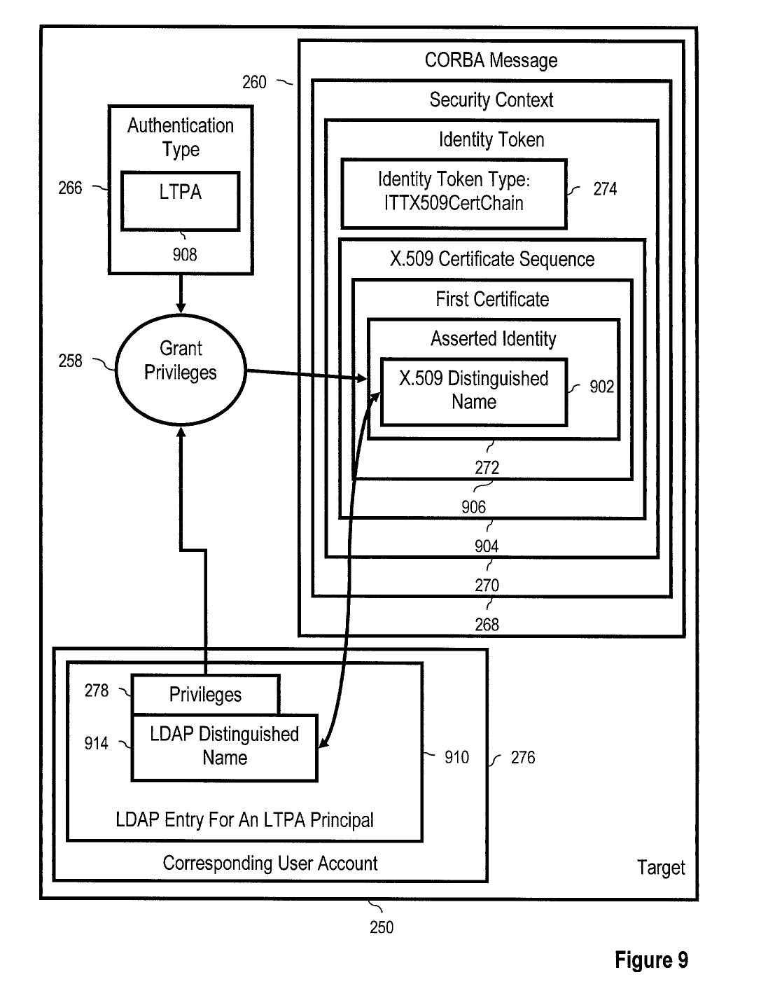

FIG. 9 sets forth a data flow diagram depicting a still further exemplary method for identity token principal mapping. In the method of FIG. 9, the identity token type (274) is “ITTX509CertChain,” and the identity token further comprises a sequence (904) of at least one X.509 certificates. The sequence of certificates includes a first X.509 certificate (906), and the asserted identity (272) comprises a distinguished name (902) of the first X.509 certificate. In the method of FIG. 9, the authentication type (266) comprises LTPA authentication (908). According to the method of FIG. 9, granting (258) authorization privileges includes granting, to the asserted identity (272), authorization privileges (278) of an LTPA principal (910) having an LDAP distinguished name (914) identical to the distinguished name (902) of the first X.509 certificate (906).

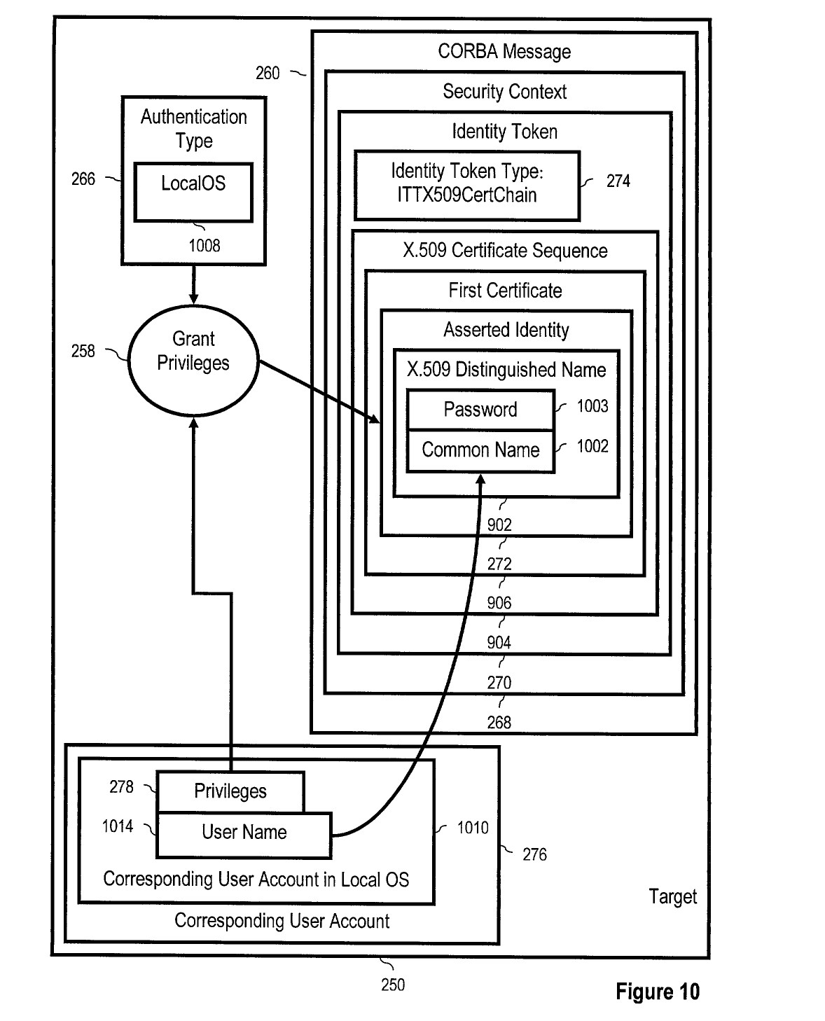

FIG. 10 sets forth a data flow diagram depicting a still further exemplary method for identity token principal mapping. In the method of FIG. 10, the identity token type (274) is “ITTX509CertChain,” and the identity token further comprises a sequence (904) of at least one X.509 certificates. The sequence of certificates includes a first X.509 certificate (906), and the asserted identity (272) comprises a distinguished name (902) of the first X.509 certificate. In the method of FIG. 10, the distinguished name (902) of the first X.509 certificate (906) includes a common name (1002), and the authentication type (266) comprises authentication in the local operating system (1008) of the target system (250). According to the method of FIG. 10, granting (258) authorization privileges further comprises granting authorization privileges (278) of a corresponding user account (1010) in the local operating system having as its user name (1014) the common name (1002) of the first X.509 certificate (906).

As mentioned earlier, authentication through the local operating system typically means that SAS calls through the local operating system's standard API with a user name (1014) and a password. In the case where the identity token type (274) is ITTX509CertChain, the common name (1002) is tested to match the user name (1014) at the level of the local operating system. The local operating system typically requires also a password for authentication. The X.509 distinguished name (902) for embodiments according to FIG. 10, therefore, typically is encoded also to include a password (1003) for use in the local operating system.

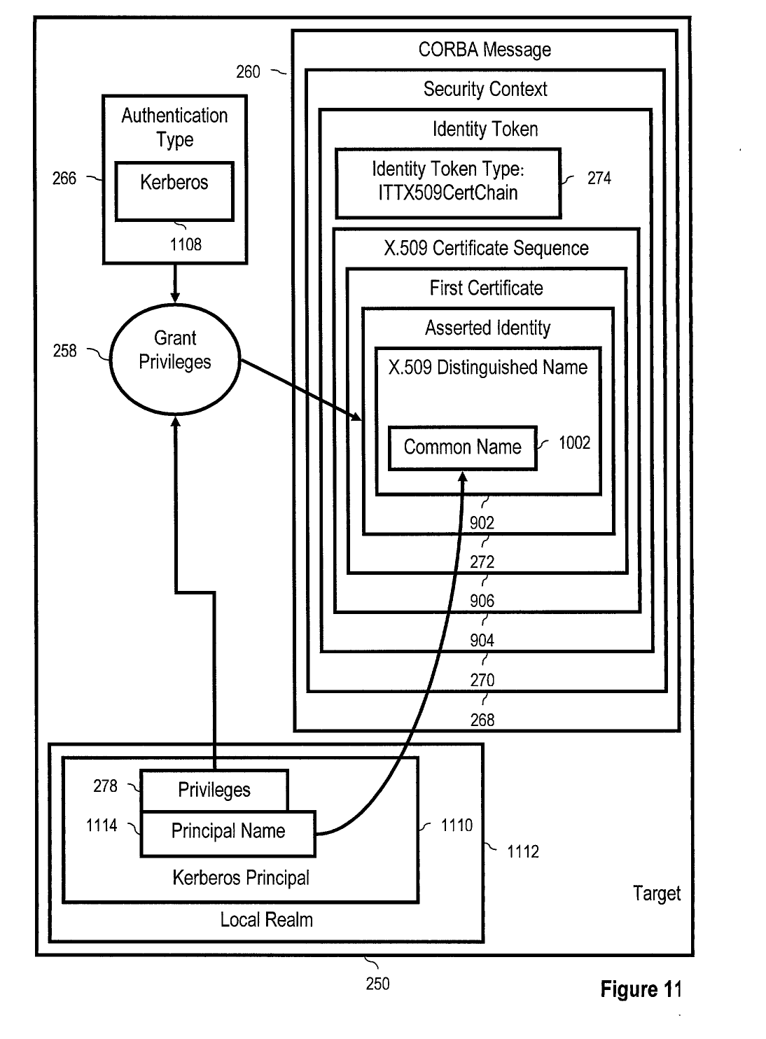

FIG. 11 sets forth a data flow diagram depicting a still further exemplary method for identity token principal mapping. In the method of FIG. 11, the identity token type (274) is “ITTX509CertChain,” and the identity token further comprises a sequence (904) of at least one X.509 certificates. The sequence of certificates includes a first X.509 certificate (906), and the asserted identity (272) comprises a distinguished name (902) of the first X.509 certificate. In the method of FIG. 11, the distinguished name (902) of the first X.509 certificate (906) further comprises a common name (1002), and the authentication type (266) comprises Kerberos authentication (1108). According to the method of FIG. 11, granting (258) authorization privileges further comprises granting authorization privileges (278) of a corresponding Kerberos principal (1110) in the local realm (1112) having as its Kerberos principal name (1114) the common name (1002) of the first X.509 certificate (906).

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for identity token principal mapping, the method comprising the steps of:
receiving in a target system a CORBA message invoking a member method on the target system, the message comprising a security context comprising an identity token further comprising an asserted identity, the identity token having an identity token type, the target system having an authentication type; and
granting to the asserted identity, in dependence upon the authentication type and in dependence upon the identity token type, authorization privileges of a corresponding user account in the target system.

2. The method of claim 1 wherein the identity token type is ITTPrincipalName and the asserted identity comprises a GSS Export Name comprising an asserted realm name and an asserted principal name.

3. The method of claim 2 wherein the authentication type comprises LTPA authentication and granting authorization privileges further comprises granting, to the asserted identity, authorization privileges of an LTPA principal whose LDAP entry comprises the asserted realm name and, as its common name, the asserted principal name.

4. The method of claim 2 wherein the authentication type comprises authentication in the local operating system of the target system and granting authorization privileges further comprises granting authorization privileges of a corresponding user account in the local operating system having as its user name the asserted principal name.

5. The method of claim 2 wherein the authentication type comprises Kerberos authentication and granting authorization privileges further comprises granting authorization privileges of a corresponding Kerberos principal in the local realm having as its principal name the asserted principal name.

6. The method of claim 1 wherein the identity token type is ITTDistinguishedName and the asserted identity comprises an X.501 distinguished name.

7. The method of claim 6 wherein the authentication type comprises LTPA authentication and granting authorization privileges further comprises granting, to the asserted identity, authorization privileges of an LTPA principal having an LDAP distinguished name identical to the X.501 distinguished name.

8. The method of claim 6 wherein the authentication type comprises authentication in the local operating system of the target system; the X.509 distinguished name comprises a common name; and granting authorization privileges further comprises granting authorization privileges of a corresponding user account in the local operating system having as its user name the common name of the X.501 distinguished name.

9. The method of claim 6 wherein the authentication type comprises Kerberos authentication; the X.509 distinguished name comprises a common name; and granting authorization privileges further comprises granting authorization privileges of a corresponding Kerberos principal in the local realm having as its Kerberos principal name the common name of the X.501 distinguished name.

10. The method of claim 1 wherein the identity token type is ITTX509CertChain; the identity token further comprises a sequence of at least one X.509 certificates, the sequence comprising a first X.509 certificate; and the asserted identity comprises a distinguished name of the first X.509 certificate.

11. The method of claim 10 wherein the authentication type comprises LTPA authentication and granting authorization privileges further comprises granting, to the asserted identity, authorization privileges of an LTPA principal having an LDAP distinguished name identical to the distinguished name of the first X.509 certificate.

12. The method of claim 10 wherein the distinguished name of the first X.509 certificate further comprises a common name; the authentication type comprises authentication in the local operating system of the target system; and granting authorization privileges further comprises granting authorization privileges of a corresponding user account in the local operating system having as its user name the common name of the first X.509 certificate.

13. The method of claim 10 wherein the distinguished name of the first X.509 certificate further comprises a common name; the authentication type comprises Kerberos authentication; and granting authorization privileges further comprises granting authorization privileges of a corresponding Kerberos principal in the local realm having as its Kerberos principal name the common name of the first X.509 certificate.

14. A system for identity token principal mapping, the system comprising:
means for receiving in a target system a CORBA message invoking a member method on the target system, the message comprising a security context comprising an identity token further comprising an asserted identity, the identity token having an identity token type, the target system having an authentication type; and
means for granting to the asserted identity, in dependence upon the authentication type and in dependence upon the identity token type, authorization privileges of a corresponding user account in the target system.

15. The system of claim 14 wherein the identity token type is ITTPrincipalName and the asserted identity comprises a GSS Export Name comprising an asserted realm name and an asserted principal name.

16. The system of claim 15 wherein the authentication type comprises LTPA authentication and means for granting authorization privileges further comprises means for granting, to the asserted identity, authorization privileges of an LTPA principal whose LDAP entry comprises the asserted realm name and, as its common name, the asserted principal name.

17. The system of claim 15 wherein the authentication type comprises authentication in the local operating system of the target system and means for granting authorization privileges further comprises means for granting authorization privileges of a corresponding user account in the local operating system having as its user name the asserted principal name.

18. The system of claim 15 wherein the authentication type comprises Kerberos authentication and means for granting authorization privileges further comprises means for granting authorization privileges of a corresponding Kerberos principal in the local realm having as its principal name the asserted principal name.

19. The system of claim 14 wherein the identity token type is ITTDistinguishedName and the asserted identity comprises an X.501 distinguished name.

20. The system of claim 19 wherein the authentication type comprises LTPA authentication and means for granting authorization privileges further comprises means for granting, to the asserted identity, authorization privileges of an LTPA principal having an LDAP distinguished name identical to the X.501 distinguished name.

21. The system of claim 19 wherein the authentication type comprises authentication in the local operating system of the target system; the X.509 distinguished name comprises a common name; and means for granting authorization privileges further comprises means for granting authorization privileges of a corresponding user account in the local operating system having as its user name the common name of the X.501 distinguished name.

22. The system of claim 19 wherein the authentication type comprises Kerberos authentication; the X.509 distinguished name comprises a common name; and means for granting authorization privileges further comprises means for granting authorization privileges of a corresponding Kerberos principal in the local realm having as its Kerberos principal name the common name of the X.501 distinguished name.

23. The system of claim 14 wherein the identity token type is ITTX509CertChain; the identity token further comprises a sequence of at least one X.509 certificates, the sequence comprising a first X.509 certificate; and the asserted identity comprises a distinguished name of the first X.509 certificate.

24. The system of claim 23 wherein the authentication type comprises LTPA authentication and means for granting authorization privileges further comprises means for granting, to the asserted identity, authorization privileges of an LTPA principal having an LDAP distinguished name identical to the distinguished name of the first X.509 certificate.

25. The system of claim 23 wherein the distinguished name of the first X.509 certificate further comprises a common name; the authentication type comprises authentication in the local operating system of the target system; and means for granting authorization privileges further comprises means for granting authorization privileges of a corresponding user account in the local operating system having as its user name the common name of the first X.509 certificate.

26. The system of claim 23 wherein the distinguished name of the first X.509 certificate further comprises a common name; the authentication type comprises Kerberos authentication; and means for granting authorization privileges further comprises means for granting authorization privileges of a corresponding Kerberos principal in the local realm having as its Kerberos principal name the common name of the first X.509 certificate.

27. A computer program product for identity token principal mapping, the computer program product comprising:
a recording medium;
means, recorded on the recording medium, for receiving in a target system a CORBA message invoking a member method on the target system, the message comprising a security context comprising an identity token further comprising an asserted identity, the identity token having an identity token type, the target system having an authentication type; and
means, recorded on the recording medium, for granting to the asserted identity, in dependence upon the authentication type and in dependence upon the identity token type, authorization privileges of a corresponding user account in the target system.

28. The computer program product of claim 27 wherein the identity token type is ITTPrincipalName and the asserted identity comprises a GSS Export Name comprising an asserted realm name and an asserted principal name.

29. The computer program product of claim 28 wherein the authentication type comprises LTPA authentication and means, recorded on the recording medium, for granting authorization privileges further comprises means, recorded on the recording medium, for granting, to the asserted identity, authorization privileges of an LTPA principal whose LDAP entry comprises the asserted realm name and, as its common name, the asserted principal name.

30. The computer program product of claim 28 wherein the authentication type comprises authentication in the local operating system of the target system and means, recorded on the recording medium, for granting authorization privileges further comprises means, recorded on the recording medium, for granting authorization privileges of a corresponding user account in the local operating system having as its user name the asserted principal name.

31. The computer program product of claim 28 wherein the authentication type comprises Kerberos authentication and means, recorded on the recording medium, for granting authorization privileges further comprises means, recorded on the recording medium, for granting authorization privileges of a corresponding Kerberos principal in the local realm having as its principal name the asserted principal name.

32. The computer program product of claim 27 wherein the identity token type is ITTDistinguishedName and the asserted identity comprises an X.501 distinguished name.

33. The computer program product of claim 32 wherein the authentication type comprises LTPA authentication and means, recorded on the recording medium, for granting authorization privileges further comprises means, recorded on the recording medium, for granting, to the asserted identity, authorization privileges of an LTPA principal having an LDAP distinguished name identical to the X.501 distinguished name.

34. The computer program product of claim 32 wherein the authentication type comprises authentication in the local operating system of the target system; the X.509 distinguished name comprises a common name; and means, recorded on the recording medium, for granting authorization privileges further comprises means, recorded on the recording medium, for granting authorization privileges of a corresponding user account in the local operating system having as its user name the common name of the X.501 distinguished name.

35. The computer program product of claim 32 wherein the authentication type comprises Kerberos authentication; the X.509 distinguished name comprises a common name; and means, recorded on the recording medium, for granting authorization privileges further comprises means, recorded on the recording medium, for granting authorization privileges of a corresponding Kerberos principal in the local realm having as its Kerberos principal name the common name of the X.501 distinguished name.

36. The computer program product of claim 27 wherein the identity token type is ITTX509CertChain; the identity token further comprises a sequence of at least one X.509 certificates, the sequence comprising a first X.509 certificate; and the asserted identity comprises a distinguished name of the first X.509 certificate.

37. The computer program product of claim 36 wherein the authentication type comprises LTPA authentication and means, recorded on the recording medium, for granting authorization privileges further comprises means, recorded on the recording medium, for granting, to the asserted identity, authorization privileges of an LTPA principal having an LDAP distinguished name identical to the distinguished name of the first X.509 certificate.

38. The computer program product of claim 36 wherein the distinguished name of the first X.509 certificate further comprises a common name; the authentication type comprises authentication in the local operating system of the target system; and means, recorded on the recording medium, for granting authorization privileges further comprises means, recorded on the recording medium, for granting authorization privileges of a corresponding user account in the local operating system having as its user name the common name of the first X.509 certificate.

39. The computer program product of claim 36 wherein the distinguished name of the first X.509 certificate further comprises a common name; the authentication type comprises Kerberos authentication; and means, recorded on the recording medium, for granting authorization privileges further comprises means, recorded on the recording medium, for granting authorization privileges of a corresponding Kerberos principal in the local realm having as its Kerberos principal name the common name of the first X.509 certificate.
